(19) United States
(12) Patent Application Publication
(10) Pub. No.: US 2024/0313600 A1
(43) Pub. Date: Sep. 19, 2024

(54) ELECTRIC MACHINE, COMPONENT FOR AN ELECTRIC MACHINE, AND MOTOR VEHICLE WITH AN ELECTRIC MACHINE

(71) Applicant: AUDI AG, Ingolstadt (DE)

(72) Inventor: Vladimir CHERNOGORSKI, Ingolstadt (DE)

(21) Appl. No.: 18/601,760

(22) Filed: Mar. 11, 2024

(30) Foreign Application Priority Data
Mar. 14, 2023 (DE) 102023106329.4

(51) Int. Cl. H02K 3/24; H02K 9/197

(52) U.S. Cl. CPC H02K 3/24; H02K 9/197

(57) ABSTRACT

An electric machine is disclosed and may include at least one component forming either a stator or a rotor and a cooling system. The at least one component may have a plurality of teeth, each of which may carry a winding wound therearound and formed from at least one electrically conductive conductor wire. The cooling system may be configured such that a cooling fluid is guided through one or more cooling channels running through an interior of at least one of the plurality of windings At least one of the one or more cooling channels is delimited laterally by conductor wires and/or conductor wire pieces of the at least one electrically conductive conductor wire arranged laterally adjacent to the cooling channel.

### BACKGROUND

### Technical Field

The present disclosure relates to an electric machine, specifically an electric machine having a cooling system running therethrough. The present disclosure further relates to a motor vehicle comprising an electric machine.

### Description of the Related Art

When operating an electric machine, its windings are energized by an electrical current, which causes the windings to heat up. Consequently, cooling of the windings is required, and for this purpose it is known from the prior art to provide cooling channels formed from separate components between the conductor wires within the winding. Corresponding systems are known, for example, from EP 3633825A1 or RU 2004117786A.

### BRIEF SUMMARY

The present disclosure provides an improved cooling configuration for windings of electric machines, in which cooling channels running through the interior of the windings are provided.

The present disclosure provides an electric machine, comprising at least one component forming either a stator or a rotor, which has a plurality of teeth each extending along a radial direction of the electric machine, each of the teeth carrying a winding wound around it and formed from at least one electrically conductive conductor wire. The electric machine may have a cooling system by which a cooling fluid may be guided through one cooling channel or through a plurality of cooling channels which runs or run through the interior of at least one of the plurality of windings. The present disclosure further discloses a component for an electric machine, formed either as a stator or a rotor and having a plurality of teeth each extending along a radial direction of the component, each of the teeth carrying a winding wound around it and formed from at least one electrically conductive conductor wire. A cooling fluid of a cooling system of the electric machine may be guided through one cooling channel or through a plurality of cooling channels which runs or run through the interior of at least one of the plurality of windings.

With regard to a housing of the electric machine, said electric machine includes a fixed stator or stand and a rotor that is rotatably mounted about an axis of rotation. If the electric machine is designed as an internal rotor, then, the rotor is arranged, relative to its axis of rotation, in an area radially further inwards than the stator. If the electric machine is designed as an external rotor, then the rotor, relative to this axis of rotation, is arranged in an area radially further outwards than the stator.

According to the present disclosure, the cooling channel or at least one of the plurality of cooling channels may be delimited laterally by conductor wires and/or conductor wire pieces of the at least one conductor wire which may be arranged laterally adjacent to the respective cooling channel.

The present disclosure provides that the cooling channel may be delimited and may thus be formed in at least one section or preferably over its entire length exclusively by the already existing conductor wires or conductor wire pieces. In other words, the cooling channel may be delimited by the outer surfaces of the conductor wires or conductor wire pieces arranged adjacent to this cooling channel. As a result, the cooling fluid comes into immediate and direct contact with the conductor wires or conductor wire pieces, i.e., with the components of the electric machine where the heat to be dissipated is generated. In the case of the electric machine according to the disclosure, it may therefore not be necessary for heat to be transported via heat transfer elements arranged between the cooling fluid and the conductor wires or conductor wire pieces. Instead, the heat transfer may occur immediately, which increases the efficiency of the cooling effect. In addition, the present disclosure may eliminate the need for a separate component that forms the cooling channel, so that a more compact and lighter design may be achieved.

The winding may be formed from exactly one conductor wire. In such embodiments, the corresponding conductor wire may be wound continuously around the respective tooth, whereby corresponding end pieces of the conductor wire may protrude from the winding at the end, via which electrical contacting of the winding may be implemented or enable. The continuously wound structure of this conductor wire may result in sections of the conductor wire, i.e., the conductor wire pieces, each running parallel and adjacent to one another and, if necessary, delimiting the cooling channel. Alternatively, the winding may be formed from several conductor wires, which may be electrically connected in series via connecting pieces. The at least one conductor wire may include an electrically conductive material, such as a metal such as copper.

The conductor wires or conductor wire pieces delimiting the respective cooling channel being arranged laterally adjacent to the latter may enable the longitudinal directions of these conductor wires or conductor wire pieces to run parallel to one another, so that the cooling channel delimited by the respective conductor wires or conductor wire pieces also runs in a longitudinal direction parallel thereto. The cooling fluid flowing through this cooling channel moves along its longitudinal direction. In some embodiments, the cooling channel may be delimited exclusively by the laterally adjacent conductor wires and/or conductor wire pieces. However, in some embodiments, the cooling channel may additionally be delimited by further components of the electric machine that are present, such as by the tooth around which the respective winding is wound and/or by a groove base formed between this tooth and an adjacent tooth.

Definitions of relevant spatial directions in the case of the electric machine according to the present disclosure are introduced below. For example, a rotor shaft of the rotor is rotatably mounted about an axis of rotation, which extends along a longitudinal direction of the electric machine. The radial direction extends perpendicular to the longitudinal direction. A circumferential direction is in turn perpendicular to the radial direction. This means that a point rotating about the axis of rotation moves along the circumferential direction. If one of these directions is mentioned without specific reference, it refers to the electric machine according to the definitions just introduced. The longitudinal, radial and circumferential directions with regard to the component correspond to the longitudinal, radial and circumferential directions with regard to the electric machine.

The cooling fluid may be a gas. The cooling fluid may be a cooling liquid such as, for example, water or oil. In some embodiments, the cooling channel or at least one of the plurality of cooling channels may be fluid-tight laterally. This may be achieved by providing for this cooling channel the conductor wires and/or conductor wire pieces delimiting this cooling channel in contact with one another laterally and over an area. Relative to the cross section of the cooling channel, the conductor wires and/or conductor wire pieces may have point by point contact points or contact surfaces extending over a length along the circumference, which are fluid-tight with respect to the cooling fluid. This means that the cooling fluid cannot pass through the contact points or surfaces and therefore cannot exit laterally from the respective cooling channel. To form and/or enhance the fluid tightness, the conductor wires and/or conductor wire pieces may be coated with a sealing material, which may be elastically deformable.

According to some embodiments, the cooling channel may not be fluid-tight laterally. In such embodiments, the cooling fluid in the corresponding section of a cooling fluid guide implemented by way of the cooling system, such as a cooling circuit, may not be exclusively guided within the cooling channel, but may also flow laterally out of it or into it.

According to the present disclosure, in the case of the cooling channel or at least one of the plurality of cooling channels, the conductor wires and/or conductor wire pieces delimiting this cooling channel may each have an outer contour that is round and/or polygonal at least in sections when viewed in cross section. If two round outer contour sections adjoin or touch one another, then a sealing line running along the longitudinal direction of the cooling channel or the conductor wires and/or conductor wire pieces may be formed. This means that the conductor wires and/or conductor wire pieces, relative to the cross section of the cooling channel, may have point by point contact points that are fluid-tight with respect to the cooling fluid. If two flat outer contour sections adjoin or touch one another, then a sealing surface, such as a strip-like sealing surface, may be formed which runs along the longitudinal direction of the cooling channel or the conductor wires and/or conductor wire pieces. This means that the conductor wires and/or conductor wire pieces, relative to the cross section of the cooling channel, may have contact surfaces that extend over a length along the circumference and are fluid-tight with respect to the cooling fluid.

Specifically, the round outer contour may be oval or circular. The entire outer contour of the conductor wires or conductor wire pieces may be circular or elliptical, although the dimensions of these circles or ellipses may be identical. In such embodiments, relative to the cross section of the cooling channel, there may be a hexagonal circular or elliptical packing, in which the cooling channel is delimited by three conductor wires or conductor wire pieces. Alternatively, in such embodiments, there may be a square circular or elliptical packing, so that the cooling channel is delimited by four conductor wires or conductor wire pieces.

Specifically, the polygonal outer contour may be rectangular, such as square, with the corners of the rectangular outer contour being rounded. Relative to the cross section of the cooling channel, there may be a rectangular packing of the conductor wire cross sections. The cooling channel may be formed or delimited by the rounded corners of four conductor wires or conductor wire pieces. The flat sides of the conductor wires or conductor wire pieces may adjoin one another and thus a strip-like sealing surface and therefore reliable fluid tightness may be achieved. In general, with regard to the polygonal outer contour, the conductor wire cross sections may form a mosaic, with the cooling channel or at least one of the cooling channels may be formed or delimited by rounded corners of the corresponding polygons.

In the case of the electric machine according to the disclosure, at least one of the windings may be elongated along a longitudinal direction of the component and may have two longitudinal sections extending along the longitudinal direction at least in sections and two transverse sections connecting the longitudinal sections to one another and extending transversely to the longitudinal direction. The cooling channel or at least one of the plurality of cooling channels may run through at least one of the longitudinal sections. While the longitudinal sections may extend along the longitudinal direction, the transverse sections may extend perpendicular to the longitudinal and radial directions. The term “elongated” in this context means that the longitudinal sections can be more than twice, such as more than five times or more than ten times, as long as the transverse sections. In such embodiments, the cooling may be effective due to the cooling channel extending through the longitudinal section and therefore through a large part of the respective winding.

In some embodiments including the cooling channel or at least one of the plurality of cooling channels, at least two of the conductor wires and/or conductor wire pieces delimiting this cooling channel in the longitudinal section may be arranged adjacent and at a distance from one another in at least one of the transverse sections and may converge in a transition section of the respective winding that is arranged between the transverse section and the longitudinal section, such as via the area of the transition section, to introduce the cooling fluid into this cooling channel or to discharge the cooling fluid therefrom. In some embodiments, if this cooling channel is fluid-tight laterally along its longitudinal direction, an inlet or outlet opening of this cooling channel may be formed in the area of the transition section. Since the adjacent conductor wires or conductor wire pieces diverge with increasing distance from the longitudinal section, the cooling fluid may flow into or out of the respective cooling channel through the distances between these conductor wires or conductor wire pieces. The winding may be cooled in the area of the transition section as a result.

In some embodiments, the conductor wires and/or conductor wire pieces delimiting a plurality of cooling channels may be arranged in the transverse section in a plurality of layers arranged at a distance from one another, within which the conductor wires and/or conductor wire pieces may be in contact with one another. In other words, the cross sections of these conductor wires or conductor wire pieces may be arranged in layers, i.e., in rows or columns. The layers may extend perpendicular to the longitudinal direction. Within the transition section and towards the longitudinal section, the distances between the layers may decrease, such as continuously, and ultimately become zero.

In such embodiments, a spacer may be arranged between the layers, the spacer configured to keep the conductor wires and/or conductor wire pieces of different layers at a distance from one another. Due to the conductor wires or conductor wire pieces being under tensile stress in some embodiments, the spacer or spacers may be advantageous in that the resulting mechanical stress on the tooth can be dissipated via said spacer(s).

Since the spacer may be arranged in the area of the distances between the conductor wires or layers, it may represent an obstacle to the cooling fluid flowing into the respective cooling channel or flowing out of the respective cooling channel. In order to counteract this effect, the spacer may include an indentation via which the cooling fluid may be introduced into or discharged from the respective cooling channel. The indentation may be formed such that the spacer has a smaller width in sections, such as in a central area, than in the remaining area. This creates a distance between the spacer and the respective layer through which the cooling fluid may flow.

If the cooling channel is fluid-tight laterally, a winding head of the winding formed from the transverse section and two adjoining transition sections may arranged in a housing, such as a hood-like housing, that may be arranged at an axial end on the component so that the winding head is encapsulated in a fluid supply chamber which may be flooded with the cooling fluid and is delimited by the housing and from which the cooling channel or at least one of the plurality of cooling channels branches off or opens into. The winding head, which may be U-shaped, comes into contact with the cooling fluid and is therefore cooled. The fluid supply chamber may be fluidly connected to a feed or discharge channel via which the cooling fluid may be introduced into or removed from the fluid supply chamber.

The housing may include a plastic and/or a metal. The housing may be formed in one or multiple parts. The housing may be open on one side and may be placed on the winding head along the longitudinal direction via the corresponding opening. Sealing means or device may be provided in the area of the opening in order to enable the fluid-tightness of the fluid supply chamber. The border delimiting the opening, on which the sealant may be arranged, may sit on the respective tooth or the respective winding.

The cooling system may form a cooling circuit in which the cooling fluid may be conveyed by way of a conveying means or device. In such embodiments, the cooling fluid may circulate from the conveying means or device to the at least one cooling channel or to the windings and back again, i.e., it is circulated. The conveying means or device may be a cooling fluid pump. A cooling device for cooling the cooling fluid, such as a heat exchanger, may be integrated into the cooling system.

The rotor shaft of the component forming the rotor, which extends along a longitudinal direction of the electric machine and is rotatably mounted, may have or delimit at least one feed channel and/or at least one discharge channel, the feed channel and/or the discharge channel extending at least in sections along the longitudinal direction of the rotor shaft. The feed channel may lead from the conveying means or device to the at least one cooling channel. The discharge channel may lead from the at least one cooling channel to the conveying means or device. The feed channel and/or the discharge channel may be configured as a central, longitudinal bore in the rotor shaft. The feed channel and/or the discharge channel may have a hollow cylindrical or sleeve-like geometry and extend between the rotor shaft and a rotor shaft sleeve, such as a rotationally fixed rotor shaft sleeve, in which the rotor shaft may be arranged or mounted.

The cooling circuit may comprise a movable section and a fixed section. In the movable section, the cooling fluid may be guided through rotating components of the electric machine, such as through the rotor. In the fixed section, the cooling fluid may be guided through stationary components of the electric machine, such as through the conveying means or device. For the cooling fluid to pass from the fixed section to the movable section, it may be introduced into the feed channel using an introduction lance. For the cooling fluid to pass from the movable to the fixed section, it may flow through at least one transverse bore and/or lateral opening in the rotor shaft or the rotor shaft sleeve.

In some embodiments, the feed channel may open into the fluid supply chamber designed as a feed chamber. In some embodiments, the fluid supply chamber configured as a discharge chamber may open into the discharge channel. For the cooling fluid to pass from the feed channel into the feed chamber and/or from the discharge chamber into the discharge channel, the feed and/or discharge channel may each open into a transverse bore running on the rotor shaft or the rotor shaft sleeve and along the radial direction.

The teeth may be arranged along the circumferential direction. Each of the teeth may protrude radially from the circumferential direction. When viewed along the longitudinal direction, the teeth may form a star-like structure, in which the teeth may be arranged in particular equidistantly along the circumferential direction. The component may comprise exactly six teeth. Receiving grooves through which the windings extend may be formed between adjacent teeth. The teeth may extend along the longitudinal direction. The cross section of the teeth, such as the T-shaped cross section, may remain constant.

The teeth may each have a T-shape with a longitudinal bar and a cross bar when viewed in a cross section, such as a cross section extending in the radial direction, with the conductor wire being wound around the longitudinal bar. In some embodiments, the longitudinal direction of the longitudinal bar may extend along the radial direction, and the longitudinal direction of the cross bar may extend along the circumferential direction. The cross bar may be curved radially on the outside, so that an air gap, which may include a constant width, may be formed between this outer surface of the tooth and the stator or rotor. The tooth may constitute a pole shoe which brings about a desired, such as sinusoidal, field shape of the magnetic field generated by the winding towards the air gap.

The electric machine according to the present disclosure may be configured as a salient pole synchronous machine. Salient pole synchronous machines are, usually DC-excited, synchronous machines in which windings are energized to generate the DC excitation field. In contrast to full pole machines, in which the rotor has longitudinal grooves in which the windings are accommodated, in salient pole synchronous machines, teeth of the stator or rotor forming pole shoes are provided, around which the windings are wound. The electric machine according to the present disclosure, such as the salient pole synchronous machine, may be implemented as an internal rotor, in which the component is the rotor. If in this case the salient pole synchronous machine is implemented as an external pole salient pole machine, the teeth may be arranged on the stator. In the salient pole synchronous machine implemented as an inner pole salient pole machine, the teeth may be arranged on the rotor. The electric machine according to the present disclosure may be configured as an internal rotor, in which the component is the rotor, so that the electric machine is an inner pole salient pole machine.

The present disclosure further discloses a component for an electric machine. According to the present disclosure, a component provides an improved cooling concept configuration for windings of electric machines in that the cooling channel or at least one of the plurality of cooling channels may be delimited laterally by conductor wires and/or conductor wire pieces of the at least one conductor wire which are arranged laterally adjacent to the respective cooling channel. All features and advantages explained in connection with the electric machine according to the present disclosure may be equally transferred to the component according to the present disclosure, and vice versa.

The present disclosure further relates to a motor vehicle comprising an electric machine as described above. All of the features and advantages explained in connection with the electric machine according to the present disclosure and the component according to the present disclosure are equally transferable to the motor vehicle according to the disclosure, and vice versa.

The electric machine may be connected to a drive train of the motor vehicle or be a component thereof, so that torque may be transferred from the electric machine to the wheels of the motor vehicle, and/or vice versa. Specifically, the rotor or a rotor shaft of the rotor, which may form an input and/or output shaft of the electric machine, may be coupled to a drive train of the motor vehicle, so that a rotation of the rotor or the rotor shaft is transmitted to components of the drive train, and vice versa. In addition to a drive shaft and the wheels, the drive train may comprise other components that enable torque transmission between the electric machine and the wheels of the motor vehicle, such as a transmission, a clutch, and/or a differential or the like. Details in the regard are well known to those skilled in the art and will not be explained in more detail here.

The electric machine may be operable in a drive mode in which it generates a traction torque to drive the motor vehicle. In this mode, the electrical energy stored in an electrical energy storage unit of the motor vehicle may be converted into kinetic energy of the motor vehicle by way of the electric machine. The accelerating or positive torque generated by the electric machine may be transmitted to the drive train and therefore to the wheels. Specifically, the windings may be electrically energized using the energy stored in the electrical energy storage unit, whereby magnetic fields may be induced by the windings. These magnetic fields may interact with magnetic fields of other coils or permanent magnets of the electric machine in such a way that the rotation of the rotor and thus the positive torque is generated.

The electric machine may be operable in a recuperation mode in which it generates a deceleration torque for decelerating the motor vehicle. In this mode, the kinetic energy of the motor vehicle may be converted into electrical energy by way of the electric machine, which electrical energy may be stored in the electrical energy storage unit of the motor vehicle and/or may be used for operating electrical devices of the motor vehicle. For this purpose, the decelerating or negative torque of the rotor may be transmitted to the drive train and via said drive train to the wheels. Specifically, the magnetic fields of further coils or permanent magnets may cause the induction of an electrical current in the windings, with the corresponding electromagnetic interaction causing the negative torque and the current induced in the windings may be used, for example, to charge the electrical energy storage unit.

### BRIEF DESCRIPTION OF THE SEVERAL VIEWS OF THE DRAWINGS

FIG. 1 shows a schematic diagram of a motor vehicle including an electric machine with a component.

FIG. 2 shows a longitudinal section of the electric machine of the motor vehicle of FIG. 1.

FIG. 3 shows an enlarged illustration of a cross-section of the electric machine of the motor vehicle of FIG. 1.

FIG. 4 shows an enlarged illustration of box IV of FIG. 3 of an example embodiment of a conductor wire of the electric machine.

FIG. 5 shows an enlarged illustration of box IV of FIG. 3 of another example embodiment of a conductor wire of the electric machine.

FIG. 6 shows an enlarged illustration of box IV of FIG. 3 of another example embodiment of a conductor wire of the electric machine.

FIG. 7 shows an enlarged illustration of box VII of FIG. 2.

FIG. 8 shows a longitudinal section of section plane VIII-VIII of FIG. 7 through the electric machine.

### DETAILED DESCRIPTION

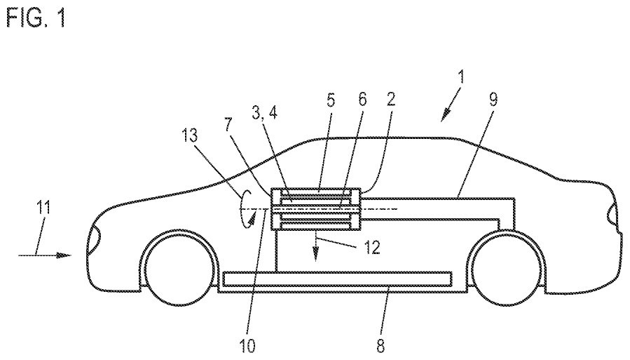

FIG. 1 shows a motor vehicle 1 according to the present disclosure according to an exemplary embodiment, comprising an electric machine 2 according to the present disclosure according to an exemplary embodiment. Electric machine 2 comprises a component 3 according to the present disclosure according to an exemplary embodiment, which in the embodiment shown in FIG. 1 is a rotor 4 of electric machine 2. Furthermore, electric machine 2 comprises a stator 5.

Electric machine 2 may be a salient pole synchronous machine, configured, for example, as an internal rotor. Rotor 4 may be arranged in an area of electric machine 2 that is radially further inwards than an area in which stator 5 is arranged. A rotor shaft 6 of rotor 4 is rotatably mounted on a housing 7 of electric machine 2, for example, by way of a ball or roller bearing. Rotor shaft 6 may be arranged in or supported by means of a rotor shaft sleeve 42, such as a rotor shaft sleeve 42 arranged in a rotationally fixed manner, which will be discussed in more detail below.

Electric machine 2 may be configured to be operated in a drive mode in which electrical energy stored in an electrical energy storage unit 8 of motor vehicle 1 is converted into kinetic energy of motor vehicle 1. A generated drive torque, which may be used to propel motor vehicle 1, may be transferable from electric machine 2 to a drive train 9 of motor vehicle 1. The drive torque may be transferable only to the rear wheels, but may also or alternatively be transferable to the front wheels. Electric machine 2 may also be operable in a recuperation mode, in which kinetic energy of motor vehicle 1 is converted into electrical energy by way of electric machine 2, which electrical energy may be used, for example, to charge electrical energy storage unit 8.

Below, with regard to electric machine 2, definitions regarding relevant spatial directions are introduced. For example, rotor shaft 6 is rotatably mounted about an axis of rotation 10, which extends along a longitudinal direction 11 of electric machine 2. A radial direction 12 extends perpendicular to longitudinal direction 11. A circumferential direction 13 is perpendicular to radial direction 12. This means that a point rotating about axis of rotation 10 moves along circumferential direction 13.

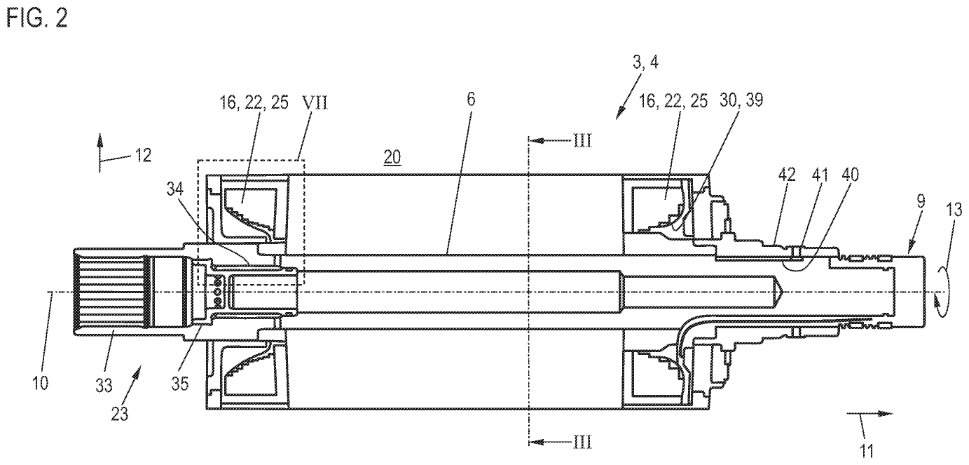

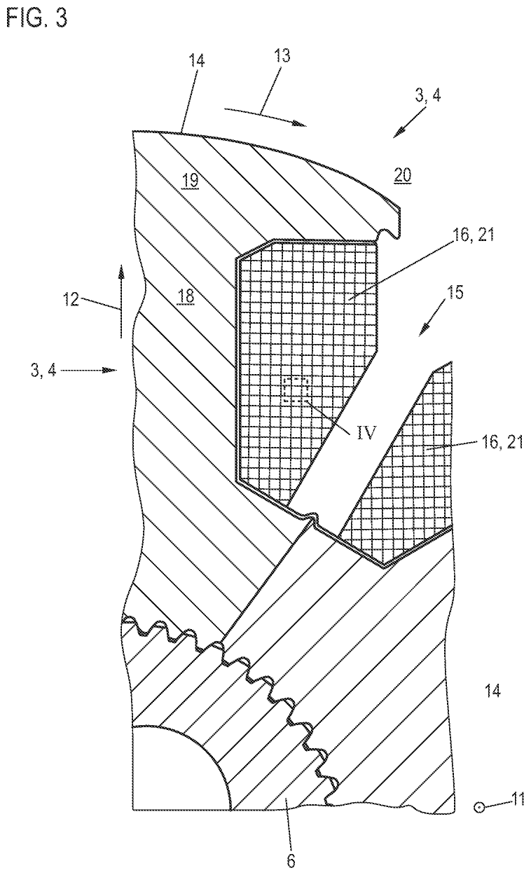

Details regarding component 3 and rotor 4 are explained below with reference to FIGS. 2 and 3. FIG. 2 shows a sectional view of component 3 or rotor 4, the sectional plane running along axis of rotation 10. FIG. 3 also shows a sectional view of rotor 4, the sectional plane being perpendicular to axis of rotation 10.

With reference to FIG. 3, component 3 or rotor 4 has a plurality of teeth 14 which may be arranged along circumferential direction 13. Six teeth 14 may be provided along circumferential direction 13, which may form a star-like structure. Receiving grooves 15 may be formed between adjacent teeth 14. Windings 16 wound around one of teeth 14 in each case may be arranged in receiving grooves 15, or windings 16 may extend through receiving grooves 15. Each of windings 16 comprises an electrically conductive conductor wire 17 made of a metal such as copper, which is wound around respective tooth 14.

Teeth 14 may each have a T-shape with a longitudinal bar 18 and a cross bar 19, the longitudinal direction of longitudinal bar 18 extending along radial direction 12, and the longitudinal direction of cross bar 19 extending along circumferential direction 13. Winding 16 may be wound around longitudinal bar 18. Cross bar 19 may be bent radially on the outside, with an air gap 20 a few millimeters wide forming between tooth 14 forming a pole shoe, and stator 5, which is not shown in FIG. 3. The T-shaped cross section of teeth 14 may remain constant along longitudinal direction 11.

Details regarding the structure of windings 16 are explained below. Each of windings 16 may include exactly one conductor wire 17, but may also comprise a plurality of conductor wires 17, which may be electrically connected in series to form corresponding winding 16 or the corresponding field coil. Windings 16 may be configured to be elongated along longitudinal direction 11, each of windings 16 having two longitudinal sections 21 and two transverse sections 22, which connect longitudinal sections 21 to one another. Conductor wire 17 may extend within longitudinal sections 21 along longitudinal direction 11. Conductor wire 17 may extend within transverse sections 22 perpendicular to longitudinal direction 11 and perpendicular to radial direction 12.

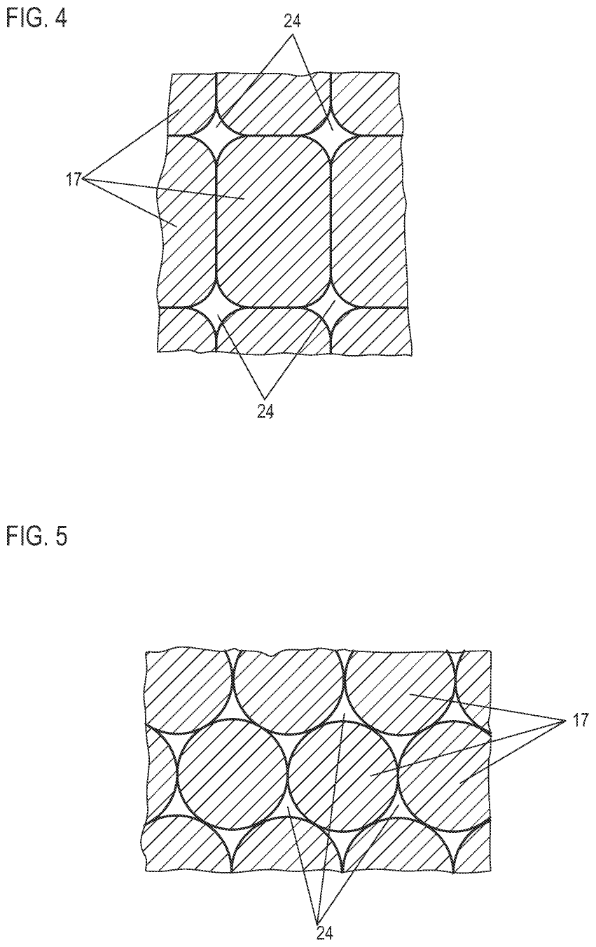

The electric machine 2 has a cooling system 23 (as shown in FIG. 2), by way of which a cooling fluid may be guided through cooling channels 24. Cooling channels 24 run through the interior of winding 16, that is to say, through respective longitudinal section 21. Details regarding conductor wire 17 and cooling channels 24 are explained below with reference to FIG. 4, which represents an enlarged section of the box marked IV in FIG. 3. In the embodiment shown in FIG. 4, cooling channels 24 may be delimited laterally by conductor wire pieces of conductor wire 17 which are arranged laterally adjacent thereto. The longitudinal directions of cooling channels 24 and the longitudinal directions of the conductor wire pieces of conductor wires 17 may run parallel to one another. Cooling channels 24 may be delimited laterally exclusively by the conductor wire pieces of conductor wire 17, but may also be additionally delimited by components of the electric machine 2 that are present, for example, by tooth 14 around which respective winding 16 is wound and/or by a groove base formed between said tooth 14 and an adjacent tooth 14. If winding 16 comprises a plurality of conductor wires 17, then cooling channels 24 may also be delimited by conductor wires 17 arranged laterally adjacent thereto.

Cooling channels 24 may be fluid-tight laterally, so that the cooling fluid guided through them, which may be a cooling liquid such as oil or water, cannot escape from respective cooling channel 24. As shown in FIG. 4, the conductor wire pieces of conductor wire 17 which delimit laterally respective cooling channel 24 may be in contact with one another laterally. The correspondingly formed contact points or surfaces may enable the fluid-tightness of respective cooling channel 24. Conductor wire 17 may have an outer sealing coating having a scaling material, which may be elastically deformable.

Details regarding the cross-sectional geometry of conductor wire 17 will be described below with reference to FIGS. 4 to 6, which each show an enlarged representation of the area marked by box IV in FIG. 3. Thus, the conductor wire pieces of conductor wire 17 may be polygonal when viewed in cross section, as shown in FIG. 4, with a rectangular outer contour being provided, for example, the corners of which may be rounded. Cooling channels 24 may be formed or delimited by the rounded corners of this outer contour.

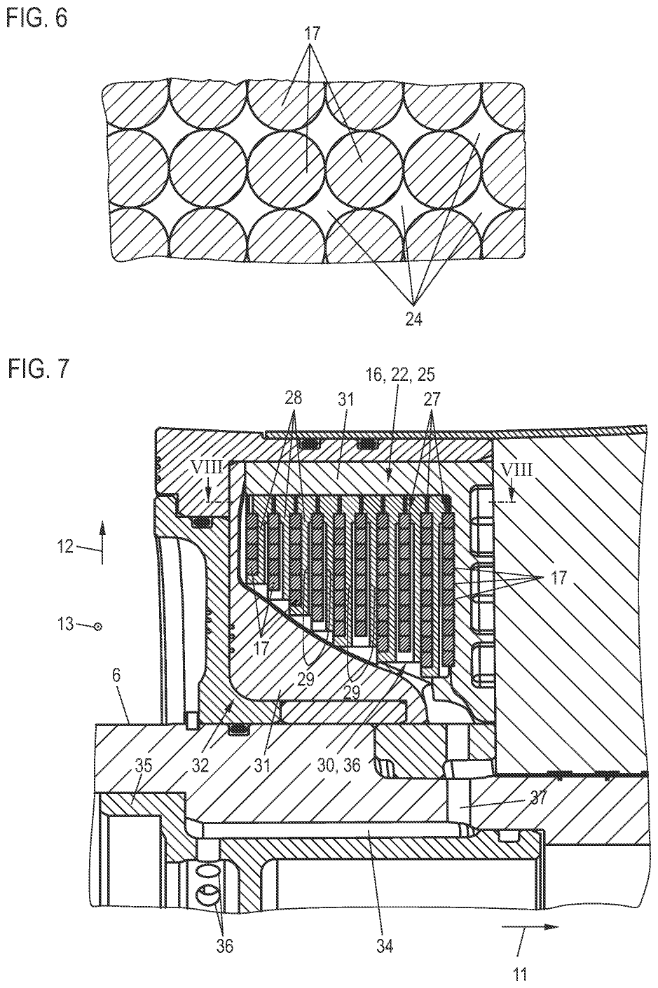

In example embodiments shown in FIGS. 5 and 6, the outer contour of the cross sections of conductor wire 17 may be round, such as circular. Referring to FIG. 5, a hexagonal circular packing may be implemented, when viewed in cross section, with cooling channels 24 each being formed from three adjacent conductor wire pieces. FIG. 6 shows an embodiment including a square circular packing, in which cooling channels 24 may each be formed by four adjacent conductor wire pieces of conductor wire 17.

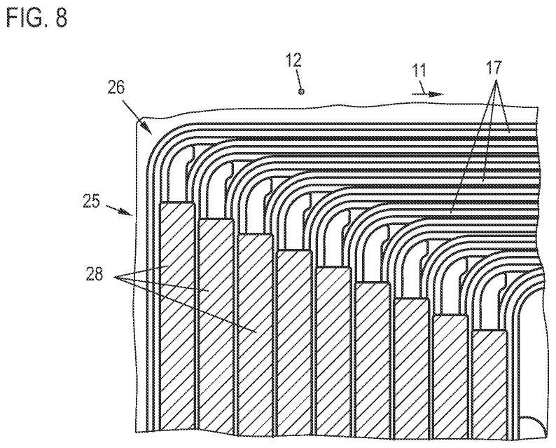

Further details regarding windings 16 will be explained below with reference to FIGS. 7 and 8. FIG. 7 shows an enlarged representation of an area of this longitudinal sectional representation of rotor 4 marked by a box VII in FIG. 2, which shows one of transverse sections 22 of one of windings 16. FIG. 8 shows a further longitudinal sectional representation of rotor 4 along the section line VIII-VIII of FIG. 7 in the area encompassing a transition section 26 of one of windings 16, which is explained in more detail below.

In the embodiment shown in FIGS. 7 and 8, each of windings 16 may comprise two winding heads 25, which, with regard to longitudinal direction 11, may adjoin the outer ends of longitudinal sections 21 of respective winding 16. In a perspective in the opposite direction of radial direction 12, winding heads 25 may be U-shaped. Accordingly, each of winding heads 25 may include one of the transverse sections 22 and two transition sections 26. Transition sections 26 may each represent one of the areas of winding 16, via which longitudinal sections 21 and transverse sections 22 may be connected to one another. In the exemplary embodiment shown, transition sections 26 may comprise curved sections of conductor wire 17 and longitudinal sections 21 and transverse sections 22 may comprise straight sections of conductor wire 17.

Based on FIGS. 7 and 8, the conductor wire pieces of conductor wire 17 which each may delimit one of cooling channels 24 may be arranged adjacent and at a distance from one another in transverse section 25. Specifically, these conductor wire pieces of conductor wire 17 may be arranged within a plurality of layers 27. The conductor wire pieces of conductor wire 17 may be in contact with one another within respective layer 27. Layers 27 may extend perpendicular to longitudinal direction 11. Layers 27 may converge in transition section 26, so that the cooling fluid may be introduced into cooling channels 24 via the area of transition section 26. Cooling channels 24 therefore may have a corresponding inlet opening in the area of transition section 26, with the cooling fluid flowing into cooling channels 24 from the outside through the distances between layers 27 in the area of respective winding head 25.

A spacer 28 may be arranged between layers 27, which may keep the conductor wire pieces of conductor wire 17 at a distance from one another or defines said distance. Spacer parts 28 may be advantageous because conductor wire 17 may be wound around tooth 14 under tension, so that the corresponding mechanical stresses may be transmitted to tooth 14 via spacers 28. Furthermore, spacers 28 may each have an indentation 29 through which the cooling fluid may be introduced into respective cooling channel 24. In the area of indentations 29, spacers 28 may have a smaller width relative to radial direction 12, so that the cooling fluid can flow there between spacer 28 and layers 27.

The aspects just explained regarding winding heads 25 and spacer parts 28 apply equally to other winding head 25 of respective winding 16, which is shown on the right-hand side in FIG. 2, with a corresponding outlet opening of cooling channel 24 being provided there. The cooling fluid may flow out there accordingly via the corresponding distances between layers 27, which may also be kept at a distance from one another via spacers 28.

Referring again to FIG. 7, winding head 25 may be encapsulated in a fluid supply chamber 30 that may be flooded with the cooling fluid. Said fluid supply chamber 30 may be arranged axially at the end on component 3 or rotor 4 and may be delimited by a housing 32 composed of two housing parts 31. The same applies analogously to the respective other winding head 25, which is shown on the right-hand side in FIG. 2.

Details regarding cooling system 23 forming a cooling circuit are explained below with reference to FIGS. 2 and 7. A conveying means or device 33 may be integrated into cooling system 21, which in the embodiment shown in FIGS. 2 and 7 may be a cooling fluid pump and by way of which the cooling fluid may be conveyed and circulated. Rotor shaft 6 may include a feed channel 34 extending along longitudinal direction 11 for guiding the cooling fluid. After the cooling fluid has passed conveying means or device 33, it may reach a feed section delimited by a conveyor-side section 35 of rotor shaft 6 via an introduction lance (not shown), from where it may enter feed channel 34 via first transverse bores 36 of the conveyor-side section 35. Feed channel 34 may be configured as a hollow cylinder or sleeve. The cooling fluid may then flow through feed channel 34 and may reach fluid supply chamber 30 configured as a supply chamber 38 via second transverse bores 37 of rotor shaft 6, which may rotate together with said rotor shaft 6 about axis of rotation 10. The cooling fluid may then reach cooling channels 24, as described above, via the distances between layers 27.

After the cooling fluid has flowed through cooling channels 24 along longitudinal direction 11, it may reach fluid supply chamber 30 configured as a discharge chamber 39. From there, it may reach a discharge channel 40 extending along longitudinal direction 11, which may be configured as a hollow cylinder or sleeve and may be delimited by rotor shaft 6 and rotor shaft sleeve 42 which may be arranged in a rotationally fixed manner. Via third transverse bores 41 of rotor shaft sleeve 42, the cooling fluid in turn may reach a cooling fluid return channel, not shown in the figures, which may lead to conveying means or device 33.

Although component 3 according to the present disclosure may form rotor 4 of electric machine 2 in the exemplary embodiment explained, stator 5 may implement component 3 and the aspects explained in this regard. In such embodiments, such as windings 16 and the aspects explained in this regard, such as cooling channel 24 or the plurality of cooling channels 24, may be implemented in stator 5.

German patent application no. 102023106329.4, filed Mar. 14, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An electric machine, comprising:
at least one component configured as a stator or a rotor, the at least one component comprising a plurality of teeth, each of the plurality of teeth extending along a radial direction of the electric machine and carrying a winding wound therearound, the winding formed from at least one electrically conductive conductor wire,
a cooling system configured such that a cooling fluid is guided through one or more cooling channels running through an interior of at least one of the plurality of windings,
wherein at least one of the one or more cooling channels is delimited laterally by conductor wires and/or conductor wire pieces of the at least one electrically conductive conductor wire arranged laterally adjacent to the respective cooling channel.

2. The electric machine according to claim 1, wherein the conductor wires and/or the conductor wire pieces of the at least one electrically conductive conductor wire delimiting the at least one of the one or more cooling channels are in lateral contact with one another such that the at least one of the one or more cooling channels are fluid-tight laterally.

3. The electric machine according to claim 1, wherein the conductor wires and/or the conductor wire pieces of the at least one electrically conductive conductor wire delimiting at least one of the one or more cooling channels each define an outer profile that is at least partially round and/or polygonal.

4. The electric machine according to claim 3, wherein when the outer profile is at least partially round, the outer profile is oval or circular.

5. The electric machine according to claim 3, wherein when the outer profile is at least partially polygonal, the outer profile is rectangular and corners of the rectangular outer profile are rounded.

6. The electric machine according to claim 1, wherein at least one of the windings is elongated along a longitudinal direction of the component and includes:
two longitudinal sections that at least partially extend along the longitudinal direction; and
two transverse sections connecting the two longitudinal sections to one another, each of the two transverse sections extending transversely relative to the longitudinal direction or at least one of the one or more cooling channels running through at least one of the two longitudinal sections.

7. The electric machine according to claim 6, wherein at least two of the conductor wires and/or conductor wire pieces delimiting at least one of the one or more cooling channels in at least one of the two longitudinal sections are arranged adjacent and at a distance from one another in at least one of the transverse sections and converge in a transition section of the respective winding that is arranged between the transverse section and the longitudinal section, and
wherein, the transition section is configured to introduce the cooling fluid into the at least one of the one or more cooling channels or to discharge the cooling fluid from the at least one of the one or more cooling channels.

8. The electric machine according to claim 7, wherein the conductor wires and/or conductor wire pieces delimiting a plurality of cooling channels are arranged in the transverse section in a plurality of layers arranged at a distance from one another, wherein the conductor wires and/or conductor wire pieces are in contact with one another.

9. The electric machine according to claim 8, wherein a spacer is arranged between a pair of the plurality of layers, the spacer configured to distance the conductor wires and/or conductor wire pieces of different layers at a distance from one another, the spacer having an indentation configured such that the cooling fluid can be introduced into or discharged from the respective cooling channel therethrough.

10. The electric machine according to claim 7, wherein a winding head of the respective winding formed from the transverse section and two adjoining transition sections is arranged in a housing arranged at an axial end on the at least one component such that the winding head is encapsulated in a fluid supply chamber configured to be flooded with the cooling fluid and such that at least one of the one or more cooling channels branches off or opens into the fluid supply chamber, the fluid supply chamber being delimited by the housing.

11. The electric machine according to claim 10, wherein the feed channel opens into the fluid supply chamber, the fluid supply channel configured as a feed chamber.

12. The electric machine according to claim 10, wherein the fluid supply chamber is configured as a discharge chamber and is configured to open into the discharge channel.

13. The electric machine according to claim 1, wherein the cooling system forms a cooling circuit configured such that the cooling fluid is conveyed by a conveying device, wherein the at least one component is configured as a rotor, wherein a rotor shaft of the at least one component extending along a longitudinal direction of the electric machine and being rotatably mounted delimits at least one feed channel and/or at least one discharge channel, the feed channel and/or the discharge channel extending at least partially along the longitudinal direction of the rotor shaft, and wherein the feed channel is configured to lead from the conveying device to the one or more cooling channel and/or the discharge channel is configured to lead from the one or more cooling channel to the conveying device.

14. The electric machine according to claim 1, wherein the plurality of teeth are arranged along a circumferential direction of the at least one component and each of the plurality of teeth protrude radially and include a T-shape having a longitudinal bar and a cross bar, the winding being wound around the longitudinal bar.

15. The electric machine according to claim 1, wherein the electric machine is a salient pole synchronous machine.

16. A motor vehicle, comprising an electric machine according to claim 1.

17. A component for an electric machine, configured as a stator or a rotor, comprising:
a plurality of teeth, each of the plurality of teeth extending along a radial direction of the component, each of the plurality of teeth carrying a winding wound therearound and formed from at least one electrically conductive conductor wire,
wherein the component is configured such that a cooling fluid of a cooling system of the electric machine is guided through at least one of one or more cooling channels running through an interior of at least one of the plurality of windings,
wherein the at least one of the one or more cooling channels is delimited laterally by conductor wires and/or conductor wire pieces of the at least one electrically conductive conductor wire arranged laterally adjacent to the respective cooling channel.
